(19) United States
(12) Patent Application Publication
(10) Pub. No.: US 2009/0120890 A1
(43) Pub. Date: May 14, 2009

(54) Wind Safety Device for Cranes

(75) Inventors: Joachim Kröll, Jurchen (DE); Hermann Franzen, Munchengladbach (DE); Jannis Moutsokapad, (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: GOTTWALD PORT TECHNOLOGY GMBH, Düsseldorf (DE)

(21) Appl. No.: 11/664,758

(22) PCT Filed: Feb. 8, 2006
(86) PCT No.: PCT/EP2006/001093

§ 371 Date: Apr. 4, 2007

(30) Foreign Application Priority Data
Feb. 11, 2005 (DE) 10 2005 006 206.7

(51) Int. Cl. B66C 15/00; B66C 23/72

(52) U.S. Cl. 212/306

(57) ABSTRACT

The invention concerns a wind safety device for at least two outdoor cranes (2a, 2b), able to move by traveling gears (6) on a jointly shared crane track (1), especially track-mounted fill gantry cranes, with holding devices engaging at or in the region of the crane track (1) to prevent the cranes (2a, 2b) from lifting up and being pulled away when certain wind speeds are exceeded, and it being possible to join together at least two neighboring cranes (2a, 2b) in the region of the traveling gears (6).

In order to achieve greater safety against the lifting up and pulling away of cranes (2a, 2b) taken out of operation due to high wind speeds prevailing, it is proposed that impact elements (10a, 10b) be arranged above the coupling on the at least two neighboring cranes (2a, 2b), lying against each other when the at least two neighboring cranes (2a, 2b) are coupled together.

The invention concerns a wind safety device for at least two outdoor cranes, able to move by traveling gears on a jointly shared crane track, with holding devices engaging at or in the region of the crane track to prevent the cranes from lifting up and being pulled away when certain wind speeds are exceeded. It should be possible to join together at least two neighboring cranes in the region of the traveling gears.

According to current rules and regulations (e.g., DIN 15 019, Part 1), cranes working outdoors must be taken out of operation after a certain wind speed and be secured against being lifted up and pulled away from the crane track by the wind. The wind speed for halting operation depends on the model of crane. Diverse holding devices for cranes are known; for the most part, use is made of track pinch bars (for example, see DD 285 747). Drag shoes, mechanical locking systems, and track brakes are also used. When using track brakes, the braking capacity to be installed is determined according to the rolling resistance of the track traveling gear, the effective wind attack surface for the crane, its form factors, and the dynamic pressure. The form factors and dynamic pressure are found by using a reference wind speed according to the location of the crane. The installed braking capacity can also be minimized by having an engine brake. Mathematical verification of crane tip-over safety is also done by using the above data and values.

Moreover, a crane connection for at least two tall cranes in harbor facilities is already known from German patent application DE 199 13 980 A1. This crane connection comprises at least one coupling piece on each crane, by which the cranes can be joined together to achieve a high stability against tipping over when the wind is blowing. This type of crane connection is supposed to have the advantage of saving on center ballast and bracing cables on the cranes. The cranes in this case are full gantry cranes, which can travel on rails by traveling gears. The coupling pieces are designed as bolt connections with corresponding shackles arranged on the cranes. Preferably, the coupling pieces can be automatically joined to each other. The coupling pieces are to be installed at the bottom, in the region of the traveling gears on the gantry, and/or at the top of the crane.

The problem of the present invention is to improve a wind safety device for cranes, especially full gantry cranes with tracks and brakes, so that a greater safety against being lifted up and pulled away by the wind is achieved for a crane that is taken out of operation on account of high wind speed.

The problem is solved by a wind safety device for at least two outdoor cranes which can travel on a jointly shared track by means of traveling gears, especially track-mounted full gantry cranes, with the features of claim 1. Advantageous embodiments of the invention are indicated in the subsidiary claims.

According to the invention, in a wind safety device for at least two outdoor cranes, able to move by traveling gears on a jointly shared crane track, especially track-mounted full gantry cranes, with holding devices engaging at or in the region of the crane track to prevent the cranes from lifting up and being pulled away when certain wind speeds are exceeded, and it being possible to join together at least two neighboring cranes in the region of the traveling gears, an improved wind safety is achieved in that impact elements are arranged above the coupling on the at least two neighboring cranes, lying against each other, when the at least two neighboring cranes are coupled together.

Thanks to the coupling of two neighboring cranes, the installed braking capacity of these two or possibly additional coupled cranes is available to protect against the crane being pulled away by the wind in the switched-off operating condition. The same is true of the lifting up of the cranes by wind force, which is opposed by twice the weight of the cranes coupled together.

In addition to the mechanical coupling of the neighboring cranes in the region of the traveling gears, the invention provides that the cranes coupled together rest against each other by impact elements above the coupling. Due to this combination of upper impact elements, which are provided solely to transmit pressure forces, and the lower mechanical coupling, one achieves an optimal protection of the cranes against wind, since the wind forces attacking the cranes are diverted by the impact elements into both cranes, especially into their gantries, and thus are absorbed and withstood by the traveling gears of both cranes. It is also important that the simultaneous mechanical locking in the region of the traveling gears prevents the cranes from being pushed apart in the region of the traveling gears. Furthermore, it is not necessary to provide for a locking and unlocking of the impact elements, which facilitates their handling.

Optimal wind protection, especially an optimal diverting of the wind forces into the traveling gears, is achieved in that the impact elements are arranged in the upper region of each crane, or in the case of full gantry cranes preferably in the region of the upper bridge trusses.

It is especially advantageous in terms of design to have the impact elements in the form of bumpers with end faces that rest against each other to absorb and divert the pressure forces when the at least two neighboring cranes are coupled together.

Especially favorable conditions result, according to one feature of the invention, when the crane directly exposed to the wind in the secured parking position at least partly covers the one or more cranes coupled to it. Thus, when the arrangement of the cranes relative to each other in the parked position on the common crane track is chosen such that at least one crane or large regions of one or more other cranes are in the lee of the crane first exposed to the wind, this reduces the effective wind attack surface, which is part of the calculation of the braking capacity to be installed, so that the actual performance of the track brakes of the respective cranes is improved.

According to the invention, track brakes or another familiar accessory such as drag shoes, mechanical locking systems, track pinch bars or the like are used as holding devices, as have been used heretofore for securing of individual cranes on the crane track or on the rails.

According to another feature of the invention, it is proposed that a coupling link be provided for the coupling of the at least two cranes driven directly next to each other, and preferably impinging on each other, with which the neighboring cranes can be interlocked. In event of an impending storm or wind speeds preventing the crane from operating, at least two of the neighboring cranes traveling on the common crane track are driven so close to each other or impinging on each other that both cranes can be interlocked with a coupling link. Once the storm danger is past, this coupling link can be easily removed again, but it joins together the two cranes or possibly several neighboring cranes with additional coupling links as a wind safety device. The cranes will then also make contact in the region of the impact elements.

In one favorable embodiment of the invention, each coupling link joins together two coupling pieces, which are fastened to each crane in the region of the traveling gear in order to absorb tensile and compressive forces acting between the neighboring cranes. The coupling by tensile and compressive connection is thus favorably provided near the ground, where an especially effective coupling of the cranes is achieved in the region of the traveling gear. Furthermore, the coupling pieces are identical in configuration, so that fabrication is simplified and the coupling of the cranes is facilitated, as the coupling pieces always fit together.

Preferably, each coupling piece is fastened to the traveling gear of each crane basically sticking out horizontally and parallel to the crane track, so that the opposite free ends of the two coupling pieces can be interlocked in removable manner.

These coupling pieces can even form the outer ends of the cranes, which makes sense when, according to another feature of the invention, the coupling link embraces appropriately configured bearing surfaces fashioned on the coupling pieces and thereby locks the coupling pieces butting against each other.

In a very simple embodiment, the coupling link has a double T-shape, while the web can be inserted in recesses in the opposite end faces of the coupling pieces so that the inner sides of the flanges of the coupling link engage with corresponding bearing surfaces on the wall-shaped coupling pieces. Coupling links of such configuration can be very easily manipulated, they are easy to install and just as easy to remove once again.

A sample embodiment of the invention is depicted in the drawing and shall be described hereafter. It shows:

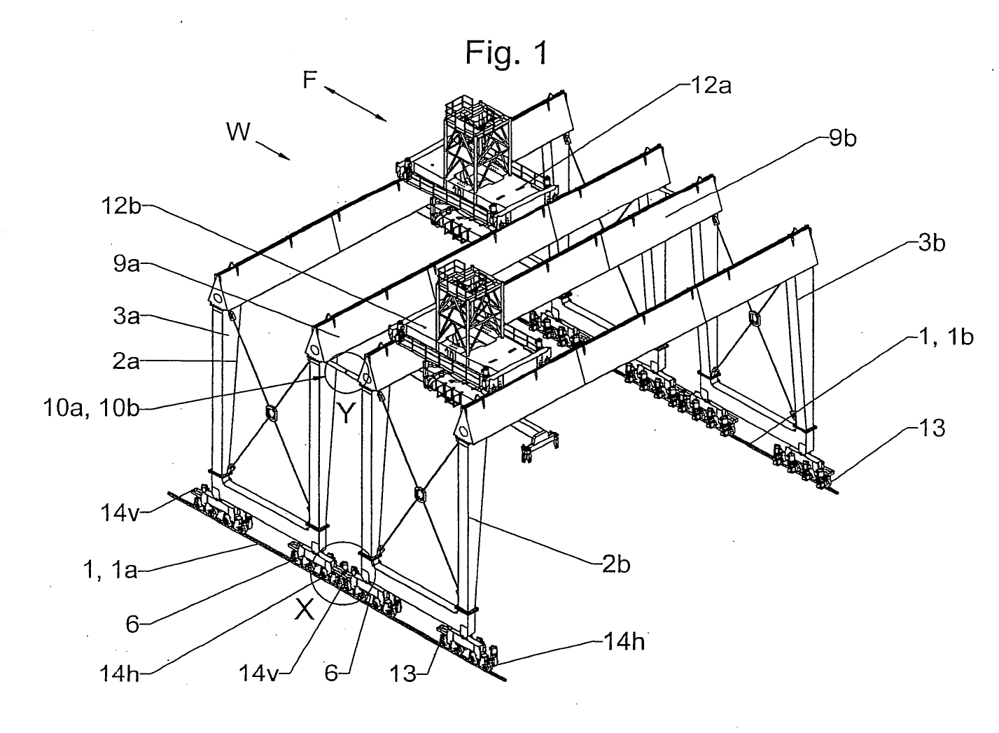

FIG. 1, a perspective view of two full gantry cranes coupled together according to the invention,

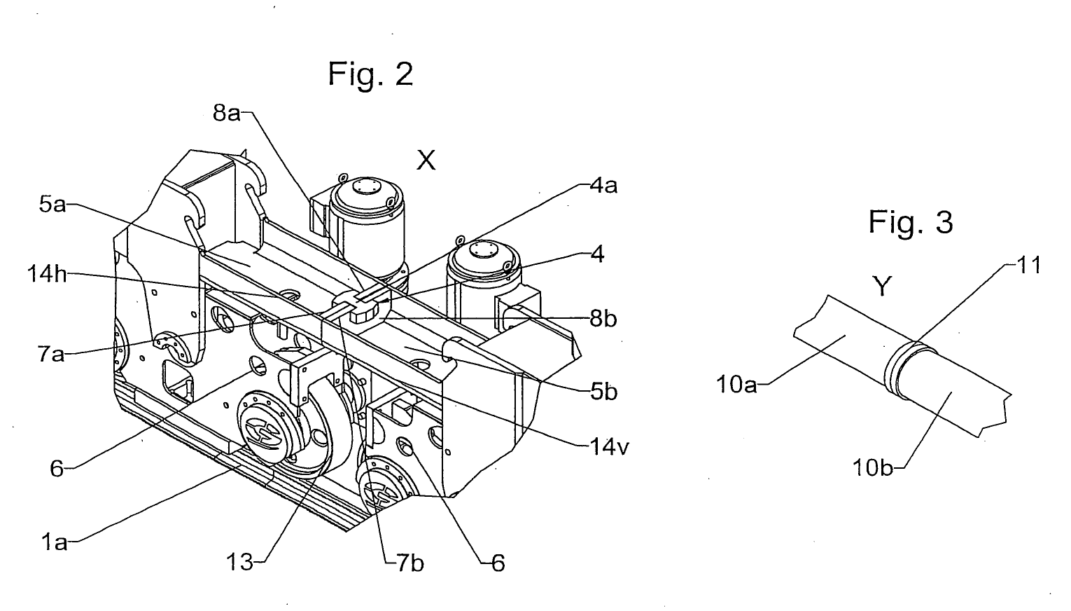

FIG. 2, a magnified detail view of FIG. 1, from the region of the coupled traveling gears of the gantry cranes, and

FIG. 3, a magnified detail view of FIG. 1 from the region of the abutting gantry stanchions of the cranes.

FIG. 1 shows a perspective view of two cranes 2a and 2b, configured as full gantry cranes and coupled together in a parked position for wind safety, being able to run on a commonly shared crane track 1. Each of the two cranes 2a, 2b is built conventionally and consists essentially of the four vertical gantry stanchions 3a, 3b, whose top ends are joined by bridge trusses 9a, 9b running transversely to the direction of travel F of the cranes 2a, 2b to form the gantry. On each of the bridge trusses 9a, 9b, a trolley 12a, 12b with the hoisting mechanisms arranged on it can travel along the bridge trusses 9a, 9b. The lower ends of the gantry stanchions 3a, 3b thrust against a traveling gear 6, which runs on rails 1a, 1b of a crane track 1. The rails 1a, 1b run parallel to and at a distance from each other.

Furthermore, the traveling gears 6 each have several wheels 13 which can run on the rails 1a, 1b, being arranged in succession in the direction of travel F for each traveling gear 6. The lower end of the respective vertical gantry stanchions 3a, 3b thrusts against the traveling gear 6 roughly in the middle, so that the traveling gear 6 looking in the direction of travel F projects in front of or behind the gantry stanchions 3a, 3b and thus they form a front end 14v and a rear end 14h in relation to the particular crane 2a, 2b.

FIG. 1 also shows the parked position of the two cranes 2a, 2b, having taken up this position when the operation of the cranes 2a, 2b had to be halted for safety reasons, due to high wind speeds. In the parked position, the cranes 2a and 2b have come up so close to each other, looking in the direction of travel F, that the two cranes 2a and 2b lie against each other in the region of their traveling gears 6 by their respective front and rear ends 14v, 14h. The traveling gears 6 and thus the cranes 2a, 2b butting against each other on each rail 1a, 1b are additionally joined together mechanically in the region of their front and rear ends 14v, 14h by means of a coupling link 4, which shall be described more closely hereafter in connection with FIG. 2.

In addition, the opposite gantry stanchions 3a, 3b lie against each other in the parked position in the region of their top ends adjacent to the bridge trusses 9a, 9b. Since, as described above, the traveling gears 6 project to the front and rear relative to the gantry stanchions 3a, 3b, looking in the direction of travel F, when the front and rear ends 14v, 14h are formed, bumper-like impact elements 10a, 10b are provided on the gantry stanchions 3a, 3b. In the parked position, the free ends of the respective impact elements 10a, 10b touch, but they are not interlocked. The impact elements 10a, 10b are simply configured as pipe segments, extending sideways, horizontally and in the direction of travel F from the gantry stanchions 3a, 3b, and their free end is closed off to form an end face 11 (see FIG. 3).

Besides the mechanical connection of the traveling gears 6 by the coupling link 4 in the parked position, the holding mechanisms of the two cranes are brought into play at the same time, say, by activating the track brakes (not shown) of each crane 2a, 2b.

FIG. 2 shows an enlarged detail view of feature X of FIG. 1, showing the region of the coupled together traveling gears 6 of the cranes 2a, 2b in their parked position. For this, a coupling piece 5a or a coupling piece 5b is firmly arranged on each traveling gear 6, forming either the front or the rear end 14v, 14h of the respective crane 2a, 2b. The coupling pieces 5a, 5b are each configured as U-shaped steel sections, which project in parallel to the crane track 1 in the direction of the neighboring crane 2a or 2b above the wheels 13 of the traveling gear 6. To form a bearing surface, the facing ends 14v, 14h of the U-shaped coupling pieces 5a, 5b are each closed off with an end wall 7a, 7b. In the parked position of the cranes 2a, 2b, as depicted, the projecting ends 14v, 14h of the coupling pieces 5a, 5b essentially lie against each other with their end walls 7a, 7b, so that compressive forces acting between the cranes 2a and 2b can be transmitted across the coupling pieces 5a, 5b between the cranes 2a and 2b.

In order to be able to transmit tensile forces as well between the cranes 2a and 2b at the same time, besides the coupling pieces 5a and 5b lying against each other there is also provided a coupling link 4, which clamps together the coupling pieces 5a and 5b and holds them against each other. The coupling link 4—as can be recognized from FIG. 2—is formed as a double T from a steel plate and is inserted by its web 4a into a corresponding recess in the two coupling pieces 5a and 5b. This upward open recess is provided in an end wall 7a, 7b closing off the particular coupling piece 5a, 5b, forming at the same time a bearing surface 8a, 8b at the side away from the bearing surface for the inner sides of the flanges of the double T-shaped coupling link 4 when these flanges engage with the end walls 7a and 7b of the coupling pieces 4. In this way, the two cranes 2a and 2b are interlocked with each other and thereby provide a definitely greater safety against wind and storm than conventional devices for individually secured cranes.

Especially favorable conditions occur when the second crane 2b stands essentially in the lee of the first crane 2a, which is the case when the wind is blowing from a direction W parallel to the direction of travel F. Lower wind forces then act on the second crane 2b, so that this can take over a portion of the braking performance required for the directly exposed crane 2a, thanks to the coupling with the first crane 2a.

FIG. 3 shows an enlarged detail view of feature Y of FIG. 1, concerning the region of the impact elements 10a, 10b of the cranes 2a, 2b, lying against each other in the parked position. These are provided to protect the cranes 2a, 2b from tipping over under high wind speeds. The free ends of the impact elements 10a, 10b lie against each other with their facing end walls 11 as soon as the coupling pieces 5a and 5b of the traveling gears 6 also abut with their end faces. In this way, the cranes 2a, 2b also thrust against each other in the top region and thereby substantially increase the restoring moment of the cranes 2a, 2b under wind and storm. The free ends of the impact elements 10a, 10b are not interlocked with each other.

### LIST OF REFERENCE NUMBERS

1 Crane track
1a Rail
1b Rail
2a First crane
2b Second crane
3a Gantry stanchion
3b Gantry stanchion
4 Coupling link
4a Web
5a Coupling piece
5b Coupling piece
6 Traveling gear
7a End wall
7b End wall
8a Bearing surface
8b Bearing surface
9a Bridge truss
9b Bridge truss
10a Impact element
10b Impact element
11 End face
12a Trolley
12b Trolley
13 Wheels
14v Front end
14h Rear end
F Direction of travel
W Wind direction
X Enlarged cutout
Y Enlarged cutout

1. A wind safety device for at least two outdoor cranes able to move by traveling gears on a jointly shared crane track, comprising:
holding devices engaging the at least two cranes at or in the region of the crane track to prevent the at least two cranes from being lifted up and pulled away when certain wind speeds are exceeded, wherein at least two neighboring cranes may be coupled together in the region of the traveling gears; and
impact elements are arranged above the coupling on the at least two neighboring cranes, said impact elements lying against each other when the at least two neighboring cranes are coupled together.

2. The wind safety device per claim 1, wherein the impact elements are arranged in the upper region of each crane.

3. The wind safety device per claim 2, wherein the impact elements comprise bumpers with end faces that rest against each other to absorb the pressure forces when the at least two neighboring cranes are coupled together.

4. The wind safety device per claim 3, wherein the crane directly exposed to the wind in the parking position at least partly covers the one or more cranes coupled to it.

5. The wind safety device per claim 4, wherein track brakes or other accessories such as drag shoes, mechanical locking systems, track pinch bars are used as the holding devices.

6. The wind safety device per claim 5, wherein a coupling link is provided for the coupling of the at least two cranes, said at least two cranes being one of neighboring and impinging on each other, wherein the coupling link can interlock the at least two cranes.

7. The wind safety device per claim 6, wherein each coupling link joins together two coupling pieces that are fastened to each crane in the region of the traveling gear, wherein said coupling pieces absorb tensile and compressive forces acting between the one of neighboring and impinging cranes.

8. The wind safety device per claim 7, wherein each coupling piece is fastened to the traveling gear of each respective crane and protrudes generally horizontal and parallel to the crane track, wherein opposite free ends of the two coupling pieces can be interlocked in removable manner by the coupling link.

9. The wind safety device per claim 8, wherein the coupling link engages appropriately configured bearing surfaces on the coupling pieces and locks the coupling pieces abutting against each other.

10. The wind safety device per claim 9, wherein the coupling link has an I-shape, including a web and at least two flange elements, wherein said web can be inserted in recesses in opposite end walls of the coupling pieces, wherein inner sides of the flange elements of the coupling link engage the bearing surfaces on the coupling pieces.

11. The wind safety device per claim 1, wherein the impact elements are in the form of bumpers with end faces that rest against each other to absorb the pressure forces when the at least two neighboring cranes are coupled together.

12. The wind safety device per claim 11, wherein the crane directly exposed to the wind in the parking position at least partly covers the one or more cranes coupled to it.

13. The wind safety device per claim 12, wherein track brakes or other accessories such as drag shoes, mechanical locking systems, track pinch bars are used as the holding devices.

14. The wind safety device per claim 13, wherein a coupling link is provided for the coupling of the at least two cranes, said at least two cranes being one of neighboring and impinging on each other, wherein the coupling link can interlock the at least two cranes.

15. The wind safety device per claim 14, wherein each coupling link joins together two coupling pieces that are fastened to each crane in the region of the traveling gear, wherein said coupling links absorb tensile and compressive forces acting between the neighboring cranes.

16. The wind safety device per claim 15, wherein each coupling piece is fastened to the traveling gear of each respective crane and protrudes generally horizontal and parallel to the crane track, wherein opposite free ends of the two coupling pieces can be interlocked in removable manner by the coupling link.

17. The wind safety device per claim 16, wherein the coupling link engages appropriately configured bearing surfaces on the coupling pieces and locks the coupling pieces abutting against each other.

18. The wind safety device per claim 17, wherein the coupling link has an I-shape, including a web and at least two flange elements, wherein said web can be inserted in recesses in opposite end walls of the coupling pieces, wherein inner sides of the flange elements of the coupling link engage the bearing surfaces on the coupling pieces.

19. The wind safety device per claim 1, wherein the crane directly exposed to the wind in the parking position at least partly covers the one or more cranes coupled to it.

20. The wind safety device per claim 1, wherein track brakes or other accessories such as drag shoes, mechanical locking systems, track pinch bars are used as the holding devices.

21. The wind safety device per claim 1, wherein a coupling link is provided for the coupling of the at least two cranes, said at least two cranes being one of neighboring and impinging on each other, wherein the coupling link can interlock the at least two cranes.

22. The wind safety device per claim 21, wherein each coupling link joins together two coupling pieces that are fastened to each crane in the region of the traveling gear, wherein said coupling links absorb tensile and compressive forces acting between the neighboring cranes.

23. The wind safety device per claim 22, wherein each coupling piece is fastened to the traveling gear of each respective crane and protrudes generally horizontal and parallel to the crane track, wherein opposite free ends of the two coupling pieces can be interlocked in removable manner by the coupling link.

24. The wind safety device per claim 21, wherein the coupling link engages appropriately configured bearing surfaces on the coupling pieces and locks the coupling pieces abutting against each other.

25. The wind safety device per claim 24, wherein the coupling link has an I-shape, including a web and at least two flange elements, wherein said web can be inserted in recesses in opposite end walls of the coupling pieces, wherein inner sides of the flange elements of the coupling link engage the bearing surfaces on the coupling pieces.

26. The wind safety device of claim 1, said cranes being full gantry cranes, wherein the impact elements are arranged in the region of the upper bridge trusses.
